(19) United States
(12) Patent Application Publication
(10) Pub. No.: US 2009/0265231 A1
(43) Pub. Date: Oct. 22, 2009

(54) ONLINE DISCOUNT OPTIMIZER SERVICE

(75) Inventor: Eugene S. Evanitsky, Pittsford, NY (US)

Correspondence Address: Xerox Corporation (CDFS), 445 Broad Hollow Rd.-Suite 420, Melville, NY, 11747, US

(73) Assignee: Xerox Corporation, Norwalk, CT (US)

(21) Appl. No.: 12/107,333

(22) Filed: Apr. 22, 2008

(51) Int. Cl. G06Q 30/00; G06N 5/02; G06F 15/16; H04L 9/32

(52) U.S. Cl. 705/14; 706/10; 709/203; 726/3

(57) ABSTRACT

An online shopping discount optimizer service includes a host server having a web-based interface adapted to facilitate secure customer access to the host server through a computing device. The customer is prompted by the web-based interface to sequentially communicate customer affiliation data from the computing device to the host server. The host server includes a processing module adapted to process the sequentially communicated customer affiliation data for registration with the service. A processing software application is trained to classify the processed affiliation data and selectively extract data therefrom based on the classification. The processing software application is configured to selectively present the processed affiliation data for a customer verification via the web-based interface upon at least one of an unsuccessful classification and an unsuccessful extraction of data. A storage device is in operative communication with the processing module and is configured to store the registered customer affiliation data as metadata upon at least one of the customer verification and the extraction of data. A web-based software application is configured to automatically retrieve updated shopping discount information based on the registered customer affiliation data and generate the updated shopping discount information via the web-based interface based on at least one customer request.

### BACKGROUND

1. Technical Field

The present disclosure relates to an online service, and, in particular, to a system and method for providing an online discount optimizer service.

2. Description of Related Art

When shopping, consumers are always looking for the best deal possible. Many currently available websites make price comparisons from multiple vendors to provide consumers with pricing information for a given product or service. However, these websites fail to take into consideration customer affiliations, such as memberships and payment methods used, that could make a significant difference in price. For example, organizations such as AAA, AARP, Buyers Advantage, TWCommunity Awards Club, Entertainment book, unions, clubs, and armed services, offer discounts for products and services as a reward for membership. Further, payment method companies such as MasterCard, Visa, Paypal, and Website Financing, provide promotional discounts for members making product or services purchases using these payment methods.

Merchants rarely inform the customer about what discounts may be available based on these customer affiliations since they either don't have access to the necessary information or lack the necessary technology.

### SUMMARY

In an embodiment of the present disclosure, an online shopping discount optimizer service includes a host server having a web-based interface adapted to facilitate secure customer access to the host server through a computing device. The customer is prompted by the web-based interface to sequentially communicate customer affiliation data from the computing device to the host server. The host server includes a processing module adapted to process the sequentially communicated customer affiliation data for registration with the service. A processing software application is trained to classify the processed affiliation data and selectively extract data therefrom based on the classification. The processing software application is configured to selectively present the processed affiliation data for a customer verification via the web-based interface upon at least one of an unsuccessful classification and an unsuccessful extraction of data. A storage device is in operative communication with the processing module and is configured to store the registered customer affiliation data as metadata upon at least one of the customer verification and the extraction of data. A web-based software application is configured to automatically retrieve updated shopping discount information based on the registered customer affiliation data and generate the updated shopping discount information via the web-based interface based on at least one customer request.

According to another embodiment of the present disclosure, an online shopping discount optimizer service includes a host server having a web-based interface adapted to facilitate secure customer access to the host server through use of a computing device. The customer is prompted by the web-based interface to sequentially communicate customer affiliation data from the computing device to the host server. The host server includes a processing module adapted to process the sequentially communicated customer affiliation data for registration with the service. A storage device is in operative communication with the processing module and is configured to store the registered customer affiliation data as metadata for representation via the web-based interface. A content management software application operates on the host server and is configured to process at least one customer request through the web-based interface. The content management software application is further configured to continuously process the metadata to generate at least one report based on at least one of the customer request and a detection of at least one triggering condition corresponding to the customer affiliation data. A web-based software application is configured to process the at least one customer request to provide updated shopping discount information via the web-based interface based on the customer affiliation data.

The present disclosure also provides for a method for providing an online shopping discount optimizer service. The method includes the initial steps of training the service to successfully classify at least one customer affiliation document and facilitating secure customer access to the service through a web-based interface to sequentially receive customer affiliation data communicated from the customer through use of a computing device. The method also includes the steps of processing the sequentially communicated customer affiliation data and classifying the processed customer affiliation data and selectively extracting data therefrom based on the classification. The method also includes the step of selectively presenting the processed customer affiliation data for a customer verification via the web-based interface upon at least one of an unsuccessful classification and an unsuccessful extraction of data. The method also includes the steps of registering the processed customer affiliation data with the service upon at least one of the customer verification and the extraction of data and providing updated shopping discount information via the web-based interface based on the registered customer affiliation data.

### BRIEF DESCRIPTION OF THE DRAWINGS

These and other advantages will become more apparent from the following detailed description of the various embodiments of the present disclosure with reference to the drawings wherein:

FIG. 1 is a block diagram of an online shopping discount optimizer service in accordance with the present disclosure;

FIG. 2 is a flow chart diagram illustrating a method for providing an online shopping discount optimizer service in accordance with one embodiment of the present disclosure; and

FIG. 3 is a flow chart diagram illustrating a method for providing an online shopping discount optimizer service in accordance with another embodiment of the present disclosure.

### DETAILED DESCRIPTION

Embodiments of the presently disclosed advertisement system will now be described in detail with reference to the drawings in which like reference numerals designate identical or corresponding elements in each of the several views.

The present disclosure relates to an online service, and, in particular, to an online shopping discount optimizer service. In embodiments of the present disclosure, personal affiliation information is uploaded, stored, and managed on a host system accessible by customers through the Internet through use of a computing device (e.g., computer, cell phone, etc.). The service optimizes shopping discounts for the customer based on the customer's affiliations with organizations and/or payment methods. For example, affiliations or membership with organizations such as AAA, AARP, Buyers Advantage, TWCommunity Awards Club, Entertainment Book, unions, clubs, armed services, and the like, offer discounts for the purchase of products and services as a membership reward. Similarly, payment method companies, such as MasterCard, Visa, PayPal, Website Financing, and the like, offer promotional discounts for members making product or services purchases using their payment method. Generally, the shopping discount optimizer service of the present disclosure provides a customer with shopping discounts for products and/or services based on the customer's affiliations (e.g., memberships and/or payment methods used).

Customers accessing the host server are greeted by a web-based interface adapted to provide personal services. For example, personal services may be provided by Xerox® Corporation through a Xerox® Personal Services (XPS) website. More specifically, the personal services website or XPS website may employ a user interface (UI) adapted to enable the customer to utilize a service such as Software-as-a-Service (“SaaS”) to upload and manage their affiliations or memberships. Saas is a software application delivery model where a software vendor develops a web-native software application and hosts and operates (either independently or through a third-party) the application for use by its customers over a network (e.g., the Internet). Customers do not pay for owning the software itself but rather for using the service. That is, customers may pay a periodic subscription fee (e.g., monthly, annually, etc.) for the right to use the software over the Internet (e.g., through the UI). In addition to a shopping discount optimizer service, the XPS website may provide a variety of services to which customers may subscribe and access through a common UI or through one or more related websites. Customers may pay an added fee to gain access to additional services. In this scenario, the fee for subscribing to added services may be discounted relative to the fee for the original service subscription.

The customer may utilize an imaging device (e.g., scanner, camera, cell phone, etc.) to capture images of affiliation documents and subsequently communicate the captured image data to a computing device. The computing device is adapted to upload (e.g., utilizing FTP, drag-and-drop, etc.) the imaged affiliation documents as image files (e.g., digital image files) to the host server through use of the UI of the XPS website. Once uploaded, documents are processed by the host system and presented to the customer to enable a quality assurance check, as will be described in further detail below. It should be appreciated that the customer may also upload image files from a hand-held computing device (e.g., cell phone, PDA, etc.) to the host server directly. For example, the customer may utilize a web-enabled cell phone having a camera to first, capture images of affiliation documents and second, access the XPS website to upload the captured image data to the host server. The customer may further utilize the UI to input affiliation information that may not be adapted for imaging and/or scanning. For example, customers may choose to input supplemental information such as, for example, age, veteran status, and occupation, to complement uploaded image data.

In embodiments, the service may facilitate uploading of image data and/or inputting of supplemental information through a so-called “wizard” that presents the customer with a sequence of dialog boxes. Through these dialog boxes, the customer is led through a series of steps, performing tasks in a specific sequence. In use, the wizard prompts the customer to input affiliation information (e.g., membership number, membership status, etc.) via the UI. For example, the customer may be prompted to upload, through a series of steps, imaged affiliation data and complementary data not suited for imaging. The host server processes this data, which is stored and managed by the service (e.g., utilizing content management software). In this way, the customer utilizes the wizard to identify and register affiliations with the service. Once the customer's affiliations are identified and registered with the service, the service automatically tracks discount information corresponding to a given customer affiliation. For example, the SaaS may employ a suitable web-based software application (e.g., Web 2.0®, mashup application, etc.) adapted to retrieve discount information from websites and/or databases corresponding to the customer affiliation. Upon registering an affiliation through the wizard, the most recent discount information for each customer registered affiliation is automatically and continuously updated to the host system using the web application.

In embodiments, a variety of authentication mechanisms (e.g., username, password, etc.) may be employed to prevent unauthorized access to the service. In this scenario, authenticating information such as, for example, a username and password is required to access the service and/or the personal data of the customer. Once secure access to the service is gained and the customer has uploaded the desired files to the host system, the files are processed by the host system and key data is extracted from the processed files and stored in a storage device (e.g., a database) as metadata in a user profile or folder designated for a given customer. In embodiments, the host system may, in addition to metadata, store images of the uploaded files as digital image files (e.g., JPG, GIF, PNG, TIF, etc.) or as PDF files in the storage device to provide archive protection. In this manner, the XPS may offer a guarantee that uploaded documents will not be altered once received and processed by the host system.

The SaaS may incorporate a content management software application adapted to monitor the stored metadata to track and detect one or more triggering conditions. The triggering condition may be, for example, an alert that a membership has expired or will expire and/or a notification of additional affiliations or memberships which may benefit the customer (e.g., other than the already-registered affiliations of the customer). Triggering conditions may be tracked by the content management software application as part of the service and/or via automatic connection to other services offered by the XPS. Based on the detection of a triggering condition, the service generates a report to the customer(s) regarding the triggering condition, as discussed below.

The host system may employ a suitable processing software application having optical character recognition (“OCR”) functionality to process uploaded files and extract key data therefrom for storage in the user profile of the customer. The processing software application is “trained” with sample sets of affiliation documents to enable identification of the type or classification of document processed, as will be discussed in further detail below. In embodiments, file paths to specific metadata stored in the storage device may be graphically represented as associated links (e.g., hyperlinks) on the XPS website. The customer selects an associated link to view information (e.g., document images) stored in the user profile. In this way, all associated links may be discovered by the customer through the UI and all the information in the user profile may be reviewed for accuracy. The customer can then make necessary changes to the user profile accordingly.

The service further utilizes the extracted data to automatically generate shopping discount information based on the customer's registered affiliation data. More specifically, based on customer input (e.g., a product description, a product code, a product model number, a vacation destination, hotel information, rental car information, airline information, etc.), the service provides a list or summary of discounts available. For example, if the customer wishes to vacation at a particular destination, the service provides a summary of discount information related to traveling to and vacationing at the input destination based on the registered affiliations of the customer. Discount information may include a summary of discounted products and services as well as the location and/or the amount of savings effected by the discount for each product and service. Further, the service provides a range of prices for each desired product or service and the particular affiliation(s) providing the discount. In the case of multiple prices available for a particular product or service, the service may conspicuously identify the best price for a given discount inquiry.

In other uses, the shopping discount optimizer service provides discount information for customer purchases from online vendor websites. In this scenario, the vendor website, at a suitable time during the purchase process (e.g., prior to checkout), identifies or tracks the customer's affiliation information through use of browser cookies or other suitable mechanisms to indicate to the customer discounts offered for a given purchase based on the customer's registered affiliations. Alternatively, the service provides the customer with a membership identification number that the customer may input into participating vendor websites, which the vendor uses to provide discount information for a given purchase based on the customer's registered affiliations.

In embodiments, the XPS may provide a tracking service to which affiliation organizations (e.g., AAA, AARP, unions, etc.) may subscribe to monitor value provided to customers based on affiliation with the subscribing organization. Based on discounts used by customers, the service makes corresponding historical savings data available to subscribing organizations.

For each affiliation managed by the service, the corresponding metadata may include vital information such as, for example, membership identification number, membership status, level of membership (e.g., preferred, gold, platinum, etc.). Other vital information may be included and the above list should not be construed as exhaustive. The XPS website may include other associated links representing file paths to supplemental information available to the customer (e.g., membership status, suggested purchases, suggested affiliations, recent transactions, etc.) and stored in the user profile of that customer. In embodiments, the UI may include search functionality to permit the customer to methodically search metadata and/or content stored in the user profile. That is, the customer may search and/or sort their affiliation information based on any one or more vital information parameters included in the metadata, as listed above.

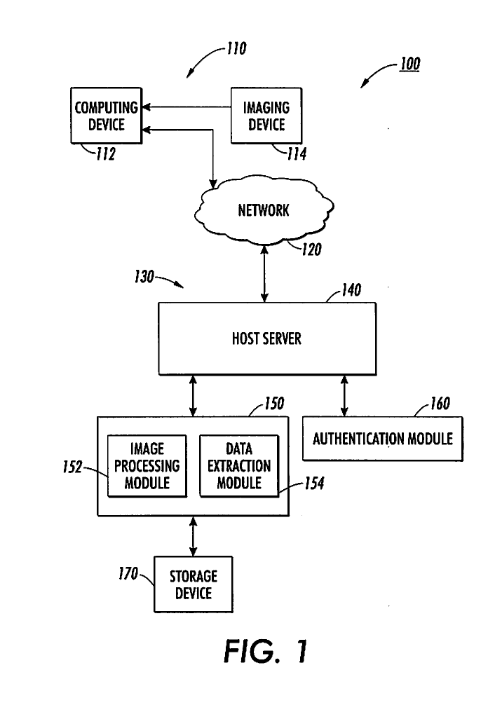

Reference is first made to FIG. 1, which shows system architecture of a data processing system 100 adapted to process, store, and manage data related to customer affiliation information in accordance with embodiments of the present disclosure.

Generally, data processing system 100 includes at least one computing device 110 and a host system 130. The host system 130 includes a host server 150 accessible by the computing device 110 via a network 120 (e.g., Internet, WAN, LAN, Bluetooth, etc.). The computing device 110 may be any known computing device (e.g., computer, hand-held computing device, cell phone, personal digital assistant (PDA), etc.) suitable to communicate data over a network (e.g., Internet, WAN, LAN, Bluetooth, etc.). In embodiments, the computing device 110 may include several components, including a processor, RAM, a hard disk drive, a USB interface, a network interface, a computer display/monitor, a computer mouse, a computer keyboard, and/or other components. Computing device 110 may also include software adapted to provide document management functionality and/or digital image management functionality.

In the illustrated embodiment, the computing device 110 is adapted to operably communicate with an imaging device 112 (e.g., a xerographic copy device, a camera, a scanner, a cellular phone, etc.). It will be appreciated that the imaging device 112 may utilize image capture technology to scan documents which are subsequently converted to digital image files (e.g., JPG, GIF, PNG, TIF, etc.) utilizing a suitable software driver. The digital image files are subsequently communicated to the computing device 110. The customer accesses the host server 140 via the network 120 to upload the scanned image file thereto, as will be discussed in further detail below. In embodiments, the imaging device 112 and computing device 110 may be integrally formed. For example, a cell phone including an onboard camera may be utilized to scan, process, and communicate affiliation documents directly to the host server 150.

The host server 140 may be any suitable network device running any known operating system and configured to communicate data over the network 120. In other words, a computer, switch, router, gateway, network bridge, proxy device or other network device that is programmed or otherwise configured to operate as explained herein is considered an embodiment of this disclosure. It should be appreciated that any data communicated to or from the host server 140 may be encrypted by the service to ensure that customer information is kept private.

The host system 130 further includes a processing module 150 in operable communication with the host server 140. The processing module 150 includes an image processing module 152 adapted to process uploaded image files and an extraction module 154 adapted to extract data from the image files processed by the image processing module 152. In embodiments, the image processing module 152 employs an optical character recognition (“OCR”) software application to process the uploaded image files. Several optical character recognition software applications are presently commercially available (e.g., Brainware, XRCE Categorizer, etc.). It should be appreciated that embodiments of the present disclosure are adapted to operate utilizing any OCR software application within the purview of one skilled in the art. Upon processing by the OCR, the processed image files are classified (e.g., by document type) by the extraction module 154 using the processing software application. The processing software application may be the OCR itself or, alternatively, a separate software application. Based on the classification, the processing software application extracts key data from the classified document. Typically, software applications utilized to seek out data from unstructured or semi-structured documents require “training” with sample sets of unstructured data. This training enables the processing software application to recognize key data on a given document to classify the document (e.g., category of affiliation document) and, based on this classification, seek out and extract pertinent data therefrom. Typically, affiliation documents are semi-structured and include key words and information that the processing software application may be trained to detect and extract. The processing software application is “trained” with sample sets of affiliation documents and documents related thereto to enable the classification of documents and extraction of key data therefrom.

In embodiments, the service enables the customer to perform a quality assurance check of all documents processed by the system 100 prior to storage therein. For example, if the processing software application is unable to extract data from a document and/or classify the document with certainty, the customer is alerted through the UI. In response to this alert, the customer may utilize the UI to verify the classification of the document and/or the data from the document and, further, make corresponding modifications. Further, the system 100 is self-learning in that each successful classification and extraction related to a processed document enables the system 100 to accumulate a so-called “knowledge-base” of affiliation documents and information to complement the trained processing software application. In this way, the system 100 learns with each document processed, whether successfully or unsuccessfully and subsequently verified and/or modified. That is, once a document or document type has been verified and stored by the system 100, subsequent documents of the same or substantially similar type may not require verification by the customer thereafter.

The data extracted by the data extraction module 154 is stored in a storage device 170 in operative communication with the processing module 150. In embodiments, the storage device 150 may be a database or a plurality of databases in operative communication with the processing module 150. In other embodiments, the host server 140 may include one or more onboard databases.

In embodiments, the content management software application monitors the metadata stored in the storage device 170 for a triggering condition. The triggering condition may be, for example, a pending membership expiration, a suggested affiliation, etc. Upon detection of the triggering condition, the service generates, via the UI, a notice or report of such condition. In embodiments, reports may be provided graphically on the UI of the XPS website at the request of the customer. In this manner, the customer may quickly and conveniently access the service (e.g., via cell phone, laptop, etc.) to retrieve information and/or documents therefrom. Additionally or alternatively, reports may be sent from the host server 140 to the computing device 110 via a customer-selected email address over the network 120. That is, the customer may utilize the UI to specify one or more email addresses at which to receive reports and/or related information and to select a link to effect such email being sent.

Use of the data processing system 100 according to embodiments of the present disclosure will now be discussed. Starting from the computing device 110, access to a secure web portal located on the host server 140 may be gained via the network 120 using security protocols such as, for example, secure sockets layer (SSL) or secure HTTP (S-HTTP). Secure access may be managed by the authentication module 160 employing a suitable authentication mechanism. That is, once a secure link is established, the authentication module 160 may prompt the customer to input a user name and password, account number, key words, a challenge-response test (e.g., CAPTCHA™), or other identifying information to facilitate access to the service. Once secure access to the service is gained, the customer may interact with the UI to select an associated link to a particular management service such as, for example, the shopping discount optimizer service. Once a specific service is selected, the customer may upload image files and/or data to the host server 140 related to that particular service.

In embodiments, the customer may choose to receive a report pertaining to any one or more parameters such as, for example, a product to be purchased, a vacation destination, a service to be purchased, an entertainment event to be attended, etc. In this scenario, the content management software application provides, via the UI, links configured to generate a information such as reports and/or discounts offered corresponding to any one or more of the parameters listed above. For example, the customer may input a product or service description (e.g., via image capture, via UI input, etc.) prior to purchase, which the service processes and utilizes a suitable web application (e.g., a mashup application) to retrieve, via the Internet, up-to-date discounts available to the customer for that product or service based on the registered affiliations of the customer. In another scenario, the user may request discount information related to a particular vacation destination. Based on this request, the service accesses and retrieves information over the Internet and/or stored in the customer's user profile to provide discount information related to the destination. The service may provide discount information related to travel arrangements (e.g., airlines, railroad, rental car service, etc.) as well as discount information related to the destination (e.g., hotels, restaurants, activities, family entertainment, useful products such as sun block, etc.) Additional links may be provided, via the UI, that are configured to permit the customer to have discount information emailed to an email address of their choosing.

As discussed above, the service is configured to automatically update discount information for a given registered affiliation upon registration. As such, depending on how recent discount information has been updated for a given affiliation registered in the user profile, the service may or may not require information retrieval via the Internet at the time of the customer request.

In the illustrated embodiment, the data processing system 100 includes a single computing device 110 adapted to communicate with the host system 130. This configuration is illustrative only in that access to the host server 120 may be gained by any paying customer (e.g., as dictated by the authentication module 160) utilizing a suitable web-enabled computing device.

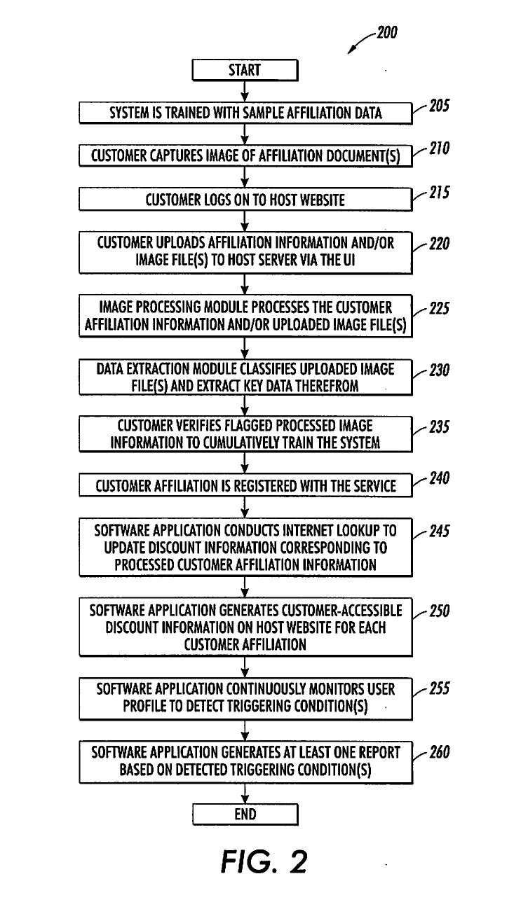

FIG. 2 illustrates a method 200 for utilizing embodiments of the system disclosed herein. In step 205, the processing software application is trained with sample sets of unstructured and/or semi-structured affiliation documents. In step 210, the customer utilizes the imaging device 114 to capture an image of the desired home improvement documents. The computing device 112 interfaces with the imaging device 114 to receive the imaged documents therefrom or, alternatively, the computing device 112 is adapted to image the documents itself (e.g., a cell phone). The computing device 112 may be adapted to manage the imaged documents as digital image files (e.g., via any suitable digital imaging software application). In step 215, the customer gains secure access to the host server 140 by logging on to the XPS website utilizing one or more authentication mechanisms (e.g., user name and password) managed by the authentication module 160. Once secure access to the host server 140 is gained, the customer utilizes the UI to access the shopping discount optimizer service and upload affiliation information and/or imaged document(s) from the computing device 112 to the host server 140 in step 220. In step 225, the processing module 150 executes the trained processing software application which, in turn, classifies the imaged document(s) and extracts key data therefrom in step 230. Upon an unsuccessful classification and/or extraction of an uploaded document, the processing software application flags the document and/or alerts the customer via the UI to allow the customer to verify the related information and make any necessary changes in step 235. In this manner, the training of the system 100 is ongoing or cumulative with each subsequent document uploaded. In step 240, the key data extracted in step 230 and/or the data verified in step 235 is utilized to register the customer affiliation with the service. In step 245, the service conducts an internet lookup of the organizations corresponding to each affiliation using the web application to retrieve up-to-date discount information. In step 250, the service generates customer-accessible discount information on the XPS website for each affiliation registered in the user profile of the customer. In step 255, the service monitors (e.g., via the content management software application) the metadata stored in the user profile to detect one or more triggering conditions and, in step 260, the service generates one or more reports based on the one or more detected triggering conditions.

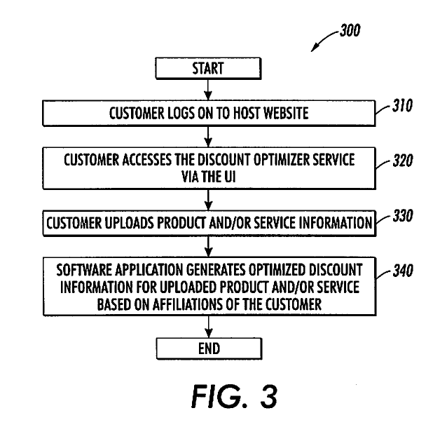

FIG. 3 illustrates a method 300 for selectively generating a document reproduction and/or report according to embodiments of the present disclosure. In step 310, the customer gains secure access to the host server 140 by logging on to the XPS website utilizing one or more authentication mechanisms (e.g., user name and password) managed by the authentication module 160. Once secure access to the host server 140 is gained, the customer accesses the shopping discount optimizer service in step 320. In step 330, the customer utilizes the UI to upload or input product or service information to the service. In step 340, the service generates optimized discount information corresponding to the product or service based on the registered affiliations of the customer.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An online shopping discount optimizer service, comprising:
a host server having a web-based interface adapted to facilitate secure customer access to the host server through a computing device, wherein the customer is prompted by the web-based interface to sequentially communicate customer affiliation data from the computing device to the host server, the host server including a processing module adapted to process the sequentially communicated customer affiliation data for registration with the service;
a processing software application trained to classify the processed affiliation data and selectively extract data therefrom based on the classification, wherein the processing software application is configured to selectively present the processed affiliation data for a customer verification via the web-based interface upon at least one of an unsuccessful classification and an unsuccessful extraction of data;
a storage device in operative communication with the processing module and configured to store the registered customer affiliation data as metadata upon at least one of the customer verification and the extraction of data; and
a web-based software application configured to automatically retrieve updated shopping discount information based on the registered customer affiliation data and generate the updated shopping discount information via the web-based interface based on at least one customer request.

2. An online shopping discount optimizer service according to claim 1, wherein the processing software application is cumulatively trained to subsequently classify the processed affiliation data successfully upon the customer verification thereof.

3. An online shopping discount optimizer service according to claim 1, wherein the at least one customer request corresponds to uploading at least one of product information and service information to the host server via the web-based interface.

4. An online shopping discount optimizer service according to claim 1, wherein the web-based interface employs a wizard to facilitate the sequential communication of the affiliation data from the computing device to the host server.

5. An online shopping discount optimizer service according to claim 1, wherein the customer affiliation data is a digital image file.

6. An online shopping discount optimizer service according to claim 5, wherein the processing module is further configured to selectively extract data from the processed information utilizing an optical character recognition application.

7. An online shopping discount optimizer service according to claim 1, wherein the service is configured to provide historical customer data to a third party, the historical customer data corresponding to at least one discount provided to the customer based on an affiliation with the third party.

8. An online shopping discount optimizer service according to claim 1, further comprising a content management software application operating on the host server and configured to continuously process the metadata to generate at least one report based on at least one of a customer request and a detection of at least one triggering condition corresponding to the customer affiliation data.

9. An online shopping discount optimizer service according to claim 8, wherein the at least one triggering condition corresponds to an expiration related to the customer affiliation data.

10. An online shopping discount optimizer service according to claim 8, wherein the at least one report is a list of recommended affiliation information based on the customer affiliation data.

11. An online shopping discount optimizer service according to claim 1, wherein the web-based software application is provided as a software-as-a-service application.

12. An online shopping discount optimizer service according to claim 1, wherein the computing device is one of a computer, a cell phone, and a personal digital assistant.

13. An online shopping discount optimizer service, comprising:
a host server having a web-based interface adapted to facilitate secure customer access to the host server through use of a computing device, wherein the customer is prompted by the web-based interface to sequentially communicate customer affiliation data from the computing device to the host server, the host server including a processing module adapted to process the sequentially communicated customer affiliation data for registration with the service;
a storage device in operative communication with the processing module and configured to store the registered customer affiliation data as metadata for representation via the web-based interface; and
a content management software application operating on the host server and configured to process at least one customer request through the web-based interface, the content management software application further configured to continuously process the metadata to generate at least one report based on at least one of the customer request and a detection of at least one triggering condition corresponding to the customer affiliation data; and
a web-based software application configured to process the at least one customer request to provide updated shopping discount information via the web-based interface based on the customer affiliation data.

14. An online shopping discount optimizer service according to claim 13, wherein the web-based interface employs a wizard to facilitate a sequenced communication of the affiliation data from the computing device to the host server.

15. An online shopping discount optimizer service according to claim 13, further including an authentication module executed on the host server and configured to authenticate access to the host server by the computing device through the web-based interface.

16. An online shopping discount optimizer service according to claim 13, wherein the at least one customer request corresponds to uploading at least one of product information and service information to the host server via the web-based interface.

17. An online shopping discount optimizer service according to claim 13, wherein the service is configured to provide historical customer data to a third party corresponding to at least one discount provided to the customer based on an affiliation with the third party.

18. A method for providing an online shopping discount optimizer service, comprising the steps of:
training the service to successfully classify at least one customer affiliation document;
facilitating secure customer access to the service through a web-based interface to sequentially receive customer affiliation data communicated from the customer through use of a computing device;
processing the sequentially communicated customer affiliation data;
classifying the processed customer affiliation data and selectively extracting data therefrom based on the classification;
selectively presenting the processed customer affiliation data for a customer verification via the web-based interface upon at least one of an unsuccessful classification and an unsuccessful extraction of data;
registering the processed customer affiliation data with the service upon at least one of the customer verification and the extraction of data; and
providing updated shopping discount information via the web-based interface based on the registered customer affiliation data.

19. A method for providing an online shopping discount optimizer service according to claim 18, wherein the verification of the registering step cumulatively trains the service to subsequently classify the processed home improvement document successfully.

20. A method for providing an online shopping discount optimizer service according to claim 18, further comprising the step of providing a wizard through the web-based interface to facilitate a sequenced communication of the customer affiliation data from the computing device to the host server.

21. A method for providing an online shopping discount optimizer service according to claim 18, further comprising the step of providing historical customer data to a third party, the historical customer data corresponding to at least one discount provided to the customer based on an affiliation with the third party.

22. A method for providing an online shopping discount optimizer service according to claim 18, further comprising the step of a continuously processing the metadata to generate at least one report based on at least one of a customer request and a detection of at least one triggering condition corresponding to the customer affiliation data.
